(19) United States
(12) Patent Application Publication
(10) Pub. No.: US 2025/0220618 A1
(43) Pub. Date: Jul. 3, 2025

(54) RECOVERING FROM RECURSIVE WIRELESS CLIENT AUTHENTICATION FAILURES

(71) Applicant: Cisco Technology, Inc., San Jose, CA (US)

(72) Inventor: Madhuri Chandrashekharaiah, Bangalore (IN)

(73) Assignee: Cisco Technology, Inc., San Jose, CA (US)

(21) Appl. No.: 19/005,665

(22) Filed: Dec. 30, 2024

(30) Foreign Application Priority Data
Dec. 29, 2023 (IN) 202341089911

(51) Int. Cl. H04W 60/04; H04W 12/06; H04W 60/06; H04W 84/12

(52) U.S. Cl. CPC H04W 60/04; H04W 12/06; H04W 60/06; H04W 84/12

(57) ABSTRACT

Recovering from recursive wireless client authentication failures may be provided. A re-association request may be received from a client device in response to the client device failing to authenticate with a network through an Access Point (AP) of the network. The re-association request may be processed. In response to processing of the re-association request resulting in another authentication failure for the client device through the AP, it may be determined that a number of authentication failures through the AP is greater than a predetermined number. An indication may be sent to the client device in response to determining that the number of authentication failures is greater than the predetermined number. The indication frame may trigger the client device to send a new association request instead of another re-association request.

### RELATED APPLICATION

Under provisions of 35 U.S.C. § 119(e), Applicant claims the benefit of Indian Provisional Application No. 20/234,1089911 filed Dec. 29, 2023, which is incorporated herein by reference.

### TECHNICAL FIELD

The present disclosure relates generally to recovering from recursive wireless client authentication failures.

### BACKGROUND

In computer networking, a wireless Access Point (AP) is a networking hardware device that allows a Wi-Fi compatible client device to connect to a wired network and to other client devices. The AP usually connects to a switch and then to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is an operating environment for recovering from recursive wireless client authentication failures;

FIG. 2 is a flow chart of a method for recovering from recursive wireless client authentication failures; and

FIG. 3 is a block diagram of a computing device.

### DETAILED DESCRIPTION

### Overview

Recovering from recursive wireless client authentication failures may be provided. A re-association request may be received from a client device in response to the client device failing to authenticate to a network through an Access Point (AP) of the network. The re-association request may be processed. In response to processing of the re-association request resulting in another authentication failure for the client device through the AP, it may be determined whether a number of authentication failures through the AP is greater than a predetermined number. An indication may be sent to the client device in response to determining that the number of authentication failures is greater than the predetermined number. The indication may trigger the client device to send a new association request instead of another re-association request.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A user authentication process may be used in networks that carry data, voice or other information to determine whether a client device seeking to access the network actually is who the client device purports to be. Typically, an authentication protocol may require the client device to prove its identity by offering a data credential that is verified in a secure manner by an authentication server. Client devices may get stuck in an infinite loop of sending re-association requests to the same Access Point (AP) of a network in certain failure cases and may not be able to recover until manual intervention. For example, a client device may get stuck in a quarantine Virtual Local Area Network (LAN) (VLAN) until a manual intervention or until manual disconnect/reconnect is performed. This may typically happen when the client device is using dual VLAN posturing method of authentication to authenticate with the network.

In the dual VLAN posturing method, a client device sends an association request to an AP of a network in order to get authenticated with the network. After the AP receives the association request, a first Extensible Authentication Protocol over LAN (EAPOL) handshake may be performed. During this first EAPOL handshake, an authentication server (for example, a Remote Authentication Dial-in User Service (RADIUS) server) may validate client credentials and EAPOL-key messages are exchanged to create and distribute encryption keys for securing a connection between the AP and the client device. After the first EAPOL handshake, the client device may be moved to a quarantine VLAN. Quarantine VLAN may grant a limited access to the network to the client device. Once in quarantine VLAN, a second EAPOL handshake may ensue to create and distribute encryption keys for securing a connection to the quarantine VLAN. After the second EAPOL handshake, the client device may receive a redirect Uniform Resource Locator (URL) and an Access Category List (ACL) from the authentication server.

A posturing may be performed on the client device side and a report of the posturing results may be sent to the authentication server. Next, the authentication server may send a Change of Authorization (CoA) instructions. The client device may then send a re-authorization or re-association request in response to the CoA instructions. A third EAPOL handshake may be performed following the re-association request. Once the third EAPOL handshake is completed, the client device may receive an access to a compliant VLAN and the ACL on the network. Each of the three EAPOL handshakes may include a 4-way handshake between the client and the authentication server.

Any deviation in the above flow while posturing, especially the 4-way handshake failures in the last or the third EAPOL handshake (for example, a network issue where M2 did not reach AP, etc.), may result in a situation where the client device may infinitely be stuck in the quarantine VLAN as it may keep sending re-association requests to the same AP. This is because, from the client device perspective, posture may be needed and the authentication server may not trigger CoA until re-posture happens, so the client device may not get past the quarantine VLAN. For example, though the AP may send a de-authentication and disassociate frame to the client device when the association request fails, as per client device vendor algorithm, the client device may end up sending a re-association request to the same AP in every new attempt and gets stuck. To break the loop, the client device may need to be disconnected so it can send a fresh association message. That is, instead of another re-association request, if the client device sends another association request (that is, a fresh association), the client device may not be stuck in the loop. The disclosure provides process for recovering from such recursive wireless client authentication failures. For example, the processes disclosed herein may enable a client device to send a new association request instead of another re-association request after a predetermined number of authentication failures with the same AP.

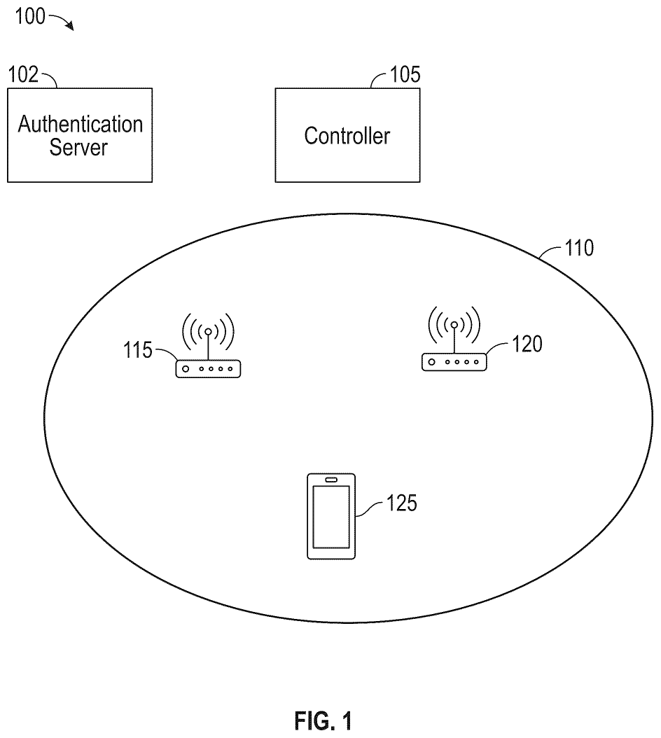

FIG. 1 shows an operating environment 100 for recovering from recursive wireless client failures. As shown in FIG. 1, operating environment 100 may comprise an authentication server 102, a controller 105, and a coverage environment 110. Coverage environment 110 may comprise, but is not limited to, a Wireless LAN (WLAN) comprising a plurality of APs that may provide wireless network access (e.g., access to the WLAN for client devices). The plurality of APs may include a first AP 115 and a second AP 120. The plurality of APs may provide wireless network access to a client device 125 as it moves within coverage environment 110.

Client device 125 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the Institute of Electrical and Electronics Engineers (IEEE) 802.11 specification standard for example.

Each of first AP 115, second AP 120, and client device 125 may use Multi-Link Operation (MLO) where they simultaneously transmit and receive across different bands and channels by establishing two or more links to two or more AP radios. These bands may comprise, but are not limited the 2.4 GHz band, the 5 GHz band, the 6 GHz band, and the 60 GHz band.

Controller 105 may comprise a Wireless LAN Controller (WLC) and may provision and control coverage environment 110 (e.g., a WLAN). Controller 105 may allow client device 125 to join coverage environment 110. In some implementations of the disclosure, controller 105 may be implemented by a Digital Network Architecture Center (DNAC) controller (i.e., a Software-Defined Network (SDN) controller. Authentication server 102 may authenticate client device 125 when client device 125 is attempting to join coverage environment 110.

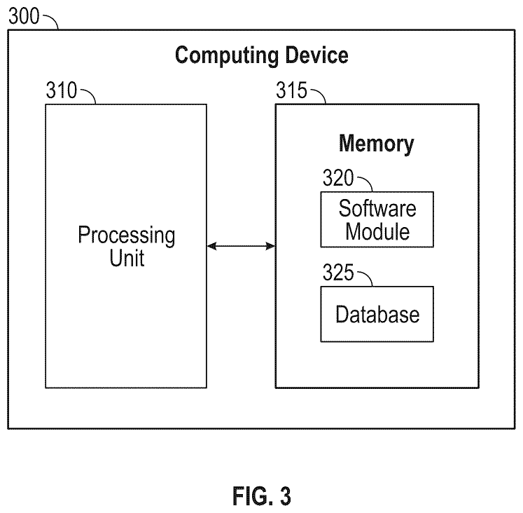

The elements described above of operating environment 100 (e.g., authentication server 102, controller 105, first AP 115, second AP 120, or client device 125) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

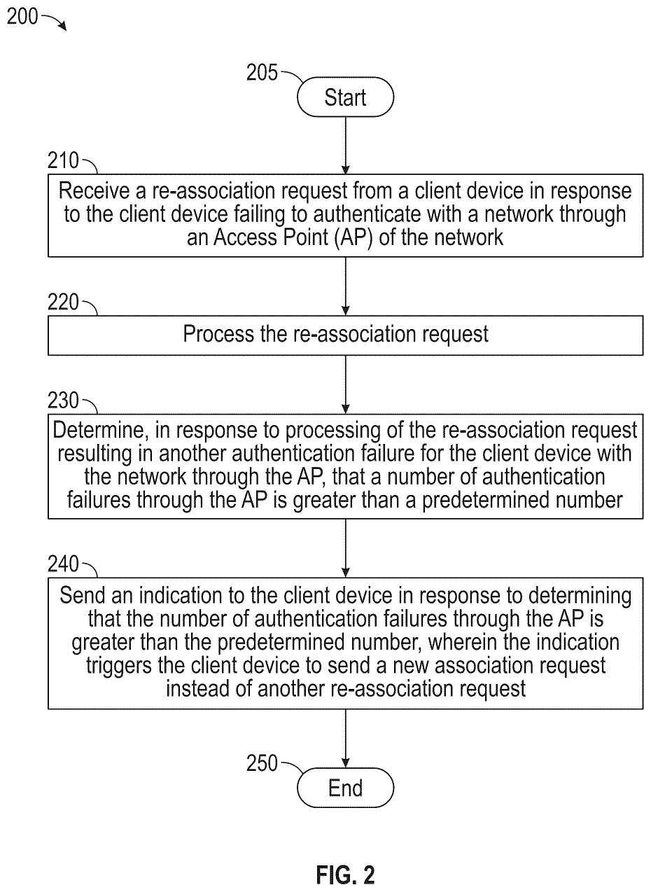

FIG. 2 is a flow chart setting forth the general stages involved in a method 200 consistent with implementations of the disclosure for recovering from recursive wireless client authentication failures. Method 200 may be implemented using first AP 115 and client device 125 as described in more detail above with respect to FIG. 1. In some implementations, method 200 may also be implemented using second AP 120 or controller 105 as described in more detail above with respect to FIG. 1. Ways to implement the stages of method 200 will be described in greater detail below.

Method 200 may begin at starting block 205 and proceed to stage 210 where first AP 115 may receive a re-association request from client device 125 in response to client device 125 failing to authenticate to a network through first AP 115. As discussed above, client device 125 may fail to authenticate with the network through first AP 115 while authenticating via dual VLAN posturing, especially the 4-way handshake failures in the last or the third EAPOL handshake (for example, a network issue where M2 did not reach AP, etc.). Client device 125 may end up in a situation where it may infinitely be stuck in the quarantine VLAN as it may keep sending re-association request to the same AP (that is, first AP 115). This is because, from client device 125 perspective, posture is needed and authentication server 102 may not trigger a CoA action until re-posture happens so client device 125 may not get past the quarantine VLAN.

After receiving the re-association request from client device 125 in response to client device 125 failing to authenticate with first AP 115 of the network at stage 210, method 200 may proceed to 220 where first AP 115 may process the re-association request. Processing of the re-association request may include performing steps of the dual VLAN posturing method including one or all of the three EAPOL handshakes described above.

Once the re-association request is processed at stage 220, method 200 may proceed to stage 230 wherein in response to processing of the re-association request resulting in another authentication failure for client device 125 through first AP 115, first AP 115 may determine that a number of authentication failures through first AP 115 is greater than a predetermined number. The predetermined number may be set by an administrator or by a device vendor of first controller 105, AP 115, or client device 125. In some examples, the predetermined number may be dynamically determined and modified for different client devices or different networks.

After determining that the number of authentication failures through first AP 115 is greater than the predetermined number at stage 240, method 200 may proceed to stage 240 where first AP 115 may send an indication to client device 125. The indication may be sent in response to determining that the number of authentication failures through first AP 115 is greater than the predetermined number. The number of authentication failures may be tracked by first AP 115 based on a Media Access Control (MAC) address associated with client device 125 as received in the re-association request. Hence, when client device 125 with a MAC address as MAC1 is continuously failing connecting to a same Basic Service Set Identifier (BSSID) (that is, a same WLAN and a same AP) a predetermined number of times, first AP 115 may send an indication in a de-authentication/dis-associate frame in response to the re-association request. The indication may trigger client device 125 to send a new association request instead of another re-association request. Method 200 may terminate at END stage 250.

In example implementations, the indication may be in form of a tag or a flag or a field in the de-authentication/dis-associate frame. The de-authentication/dis-associate frame may include a flag or a field such that first AP 115 or controller 105 may set it to a predetermined bit value to indicate that the number of authentication failures through first AP 115 is greater than the predetermined number. Therefore, in the next attempt, client device 125 may choose to send a fresh or a new association request instead of another re-association request. Further a client vendor may also monitor this bit in the flag and tweak their algorithm to send an association request instead of sending another re-association request.

In some implementations, the indication may also include a type of failure, for example, cache, handshake, timeout, posture, etc. The types of failures may be indicated as a reason code indicating that client device 125 is failing to authenticate with the network for the predetermined number of times for the same reason. In some implementation, a new type of frame, for example, a Trigger Association (TA) frame may be used to send the indication. The new type of frame may be similar to the IEEE 802.11r (that is, a fast transition frame) that may explicitly trigger client device 125 to send a fresh association request for faster recovery. A client device 125 vendor may also be informed to leverage new field/tag/frame to manipulate client vendor algorithm and trigger a fresh association instead of a reassociation request whenever there are excessive attempts due to specific reason codes.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, a method for recovering from recursive wireless client authentication failures as described above with respect to FIG. 2. Computing device 300, for example, may provide an operating environment for authentication server 102, controller 105, first AP 115, second AP 120, and client device 125. Authentication server 102, controller 105, first AP 115, second AP 120, and client device 125 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving a re-association request from a client device in response to the client device failing to authenticate with a network through an Access Point (AP) of the network;
processing the re-association request;
determining, in response to processing of the re-association request resulting in another authentication failure for the client device through the AP, that a number of authentication failures through the AP is greater than a predetermined number; and
sending an indication to the client device in response to determining that the number of authentication failures through the AP is greater than the predetermined number, wherein the indication triggers the client device to send a new association request instead of another re-association request.

2. The method of claim 1, wherein the indication is sent as a flag in a de-authentication/dis-associate frame.

3. The method of claim 1, wherein the indication is sent in a Trigger Association (TA) frame.

4. The method of claim 1, wherein the re-association request is sent in response to the client device failing to authenticate with the network using a dual Virtual Local Area Network (LAN) (VLAN) posturing method.

5. The method of claim 1, wherein the re-association request is sent in response to the client device failing to perform Extensible Authentication Protocol over LAN (EAPOL) handshake in a dual Virtual Local Area Network (LAN) (VLAN) posturing method.

6. The method of claim 1, wherein the indication comprises a reason code corresponding to a type of failure.

7. The method of claim 1, wherein the number of authentication failures is tracked based on a Media Access Control (MAC) address associated with the client device as received in the re-association request.

8. A system comprising:
a memory storage; and
a processing unit coupled to the memory storage, wherein the processing unit is operative to:
receiving a re-association request from a client device in response to the client device failing to authenticate with a network through an Access Point (AP) of the network;
processing the re-association request;
determining, in response to processing of the re-association request resulting in another authentication failure for the client device through the AP, that a number of authentication failures through the AP is greater than a predetermined number; and
sending an indication to the client device in response to determining that the number of authentication failures through the AP is greater than the predetermined number, wherein the indication triggers the client device to send a new association request instead of another re-association request.

9. The system of claim 8, wherein the indication is sent as a flag in a de-authentication/dis-associate frame.

10. The system of claim 8, wherein the indication is sent in a Trigger Association (TA) frame.

11. The system of claim 8, wherein the re-association request is sent in response to the client device failing to authenticate with the network using a dual Virtual Local Area Network (LAN) (VLAN) posturing method.

12. The system of claim 8, wherein the re-association request is sent in response to the client device failing to perform Extensible Authentication Protocol over LAN (EAPOL) handshake in a dual Virtual Local Area Network (LAN) (VLAN) posturing method.

13. The system of claim 8, wherein the indication comprises a reason code corresponding to a type of failure.

14. The system of claim 8, wherein the number of authentication failures is tracked based on a Media Access Control (MAC) address associated with the client device as received in the re-association request.

15. A non-transitory computer-readable medium that stores a set of instructions which when executed perform a method executed by the set of instructions comprising:
receiving a re-association request from a client device in response to the client device failing to authenticate with a network through an Access Point (AP) of the network;
processing the re-association request;
determining, in response to processing of the re-association request resulting in another authentication failure for the client device through the AP, that a number of authentication failures through the AP is greater than a predetermined number; and
sending an indication to the client device in response to determining that the number of authentication failures through the AP is greater than the predetermined number, wherein the indication triggers the client device to send a new association request instead of another re-association request.

16. The non-transitory computer-readable medium of claim 15, wherein the indication is sent as a flag in a de-authentication/dis-associate frame.

17. The non-transitory computer-readable medium of claim 15, wherein the indication is sent in a Trigger Association (TA) frame.

18. The non-transitory computer-readable medium of claim 15, wherein the re-association request is sent in response to the client device failing to authenticate with the network using a dual Virtual Local Area Network (LAN) (VLAN) posturing method.

19. The non-transitory computer-readable medium of claim 15, wherein the re-association request is sent in response to the client device failing to perform Extensible Authentication Protocol over LAN (EAPOL) handshake in a dual Virtual Local Area Network (LAN) (VLAN) posturing method.

20. The non-transitory computer-readable medium of claim 15, wherein the indication comprises a reason code corresponding to a type of failure.
